(19) United States
(12) Patent Application Publication
(10) Pub. No.: US 2019/0087717 A1
(43) Pub. Date: Mar. 21, 2019

(54) FOUR STABLE STATE NEURON

(71) Applicants: Sasikanth Manipatruni, Portland, OR (US); Ian A. Young, Portland, OR (US); Dmitri E. Nikonov, Beaverton, OR (US)

(72) Inventors: Sasikanth Manipatruni, Portland, OR (US); Ian A. Young, Portland, OR (US); Dmitri E. Nikonov, Beaverton, OR (US)

(73) Assignee: Intel Corporation, Santa Clara, CA (US)

(21) Appl. No.: 16/081,575

(22) PCT Filed: Apr. 1, 2016
(86) PCT No.: PCT/US2016/025640

§ 371 Date: Aug. 31, 2018

(51) Int. Cl. G06N 3/063; G06N 3/08

(52) U.S. Cl. CPC G06N 3/063; G06N 3/084

(57) ABSTRACT

One embodiment provides a four stable state neuron. The four stable state neuron includes a plurality of input elements and a plurality of coupling channels. Each input element is coupled to a respective coupling channel and each input element is to scale a respective two-dimensional input signal by a weight. The four stable state neuron further includes a first output element coupled to the plurality of coupling channels. The first output element is to receive the plurality of weighted two-dimensional input signals and to generate a two-dimensional output signal based, at least in part, on a threshold value.

### FIELD

The present disclosure relates to a neuron, in particular to, a four stable state neuron.

### BACKGROUND

Neuromorphic computing is related to processing information utilizing systems whose configuration and operation are based on a perceived understanding of the configuration and operation of neurons in biological systems. Generally, a neuron is configured to sum a plurality of weighted input signals and to fire an action potential, i.e., generate a nonzero output, if the sum is greater than a threshold. If the sum is less than the threshold, then the neuron may be configured to not fire, i.e., to remain dormant. Binary neurons are generally one dimensional, two-state elements with each state corresponding to a zero or a one. Relatively complex systems may be implemented by interconnecting a plurality of binary neurons with corresponding relatively complex interconnects.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a four stable state neuron consistent with several embodiments of the present disclosure;

FIG. 2 illustrates a functional block diagram of one example four stable state neuron including a plurality of four stable state magnets consistent with one embodiment of the present disclosure;

FIG. 3 illustrates a top view and a side view of a four stable state magnet assembly consistent with one embodiment of the present disclosure;

FIG. 4 illustrates a neural network portion that includes two interconnected example four stable state neurons consistent with one embodiment of the present disclosure;

FIG. 5 illustrates a functional block diagram of a system consistent with several embodiments of the present disclosure;

FIG. 6 illustrates a functional block diagram of a feedforward neural network related to a back propagation technique;

FIG. 7 is a flowchart of supervised learning operations according to various embodiments of the present disclosure;

FIG. 8 is a flowchart of neuromorphic computing operations according to various embodiments of the present disclosure; and

FIG. 9 is a flowchart of unsupervised learning operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a four stable state neuron. The four stable state neuron is configured to receive a plurality of two-dimensional input signals with each dimension having two stable states for a total of four states. The four stable state neuron is configured to determine a weighted sum of the two-dimensional input signals. Similar to the input signals, the weighted sum has two dimensions. The four stable state neuron is further configured to provide a two-dimensional output signal based, at least in part, on the weighted sum of the input signals and based, at least in part, on a threshold value. For example, the weighting of each input signal may be implemented by a respective input four stable state magnet and the summing may be implemented by an output four stable state magnet, as described herein. The states correspond to saturation states, i.e., easy axes of the four stable state magnet. The states further correspond to orientation of electron spin currents that may be modulated by the magnet(s). Thus, the four stable state neuron may receive a plurality of two-dimensional input signals and is configured to provide a two-dimensional output signal.

The four stable state neuron includes a plurality of input elements and a plurality of coupling channels. Each input element is coupled to a respective coupling channel. Each input element is configured to scale a respective two-dimensional input signal by a weight. A first dimension of each two-dimensional input signal corresponds to a first spin current having a first orientation and a second dimension of each two-dimensional input signal corresponds to a second spin current having a second orientation.

The four stable state neuron further includes a first output element coupled to the plurality of coupling channels. The first output element is configured to receive the plurality of weighted two-dimensional input signals, to sum the plurality of weighted first spin currents and a first threshold value and to sum the plurality of weighted second spin currents and a second threshold value to generate a two-dimensional output signal.

A plurality of four stable state neurons may be coupled together, i.e., interconnected, in an artificial neural network. Each interconnect may correspond to a channel configured to carry one or more spin currents from a source neuron to a receiving neuron. In other words, each interconnect may be configured to carry a two-dimensional signal that corresponds to a respective two-dimensional output signal of a source four stable state neuron.

Each two-dimensional signal may thus include a first dimension that corresponds to a first spin current and a second dimension that corresponds to a second spin current. The first spin current may be oriented (i.e., magnetic dipole orientation of spin) substantially perpendicular (i.e., ±one degree) relative to the second spin current. Each spin current may have two states corresponding to a positive or a negative orientation, i.e., 180° difference between the positive and negative orientations.

A source neuron may be coupled to one or more receiving neurons and a receiving neuron may be coupled to one or more source neurons. Each interconnect may have an associated weight at the receiving neuron that is related to operation of the source neuron. The weights may be determined via a learning technique that is supervised or unsupervised. For example, learning techniques may include, but are not limited to, back propagation, delta rule, Oja-rule based Hebbian and/or principal component analysis.

Interconnects associated with four stable state neurons may be relatively less complex than interconnects configured to couple binary neurons. Interconnects associated with four stable state neurons are configured to carry two-dimensional data with two states per dimension for a total of four states. In other words, rather than two interconnects configured to carry one dimension (and two states), one interconnect is configured to carry two dimensions and four states thus, fewer interconnects for a same number of dimensions and/or states.

An apparatus, method and/or system are configured to train a neural network that includes a plurality of interconnected four stable state neurons to determine associated weights. The training may be supervised or unsupervised. The trained neural network may then be utilized for related neuromorphic computing operations, e.g., pattern recognition, regression analysis, classification, etc.

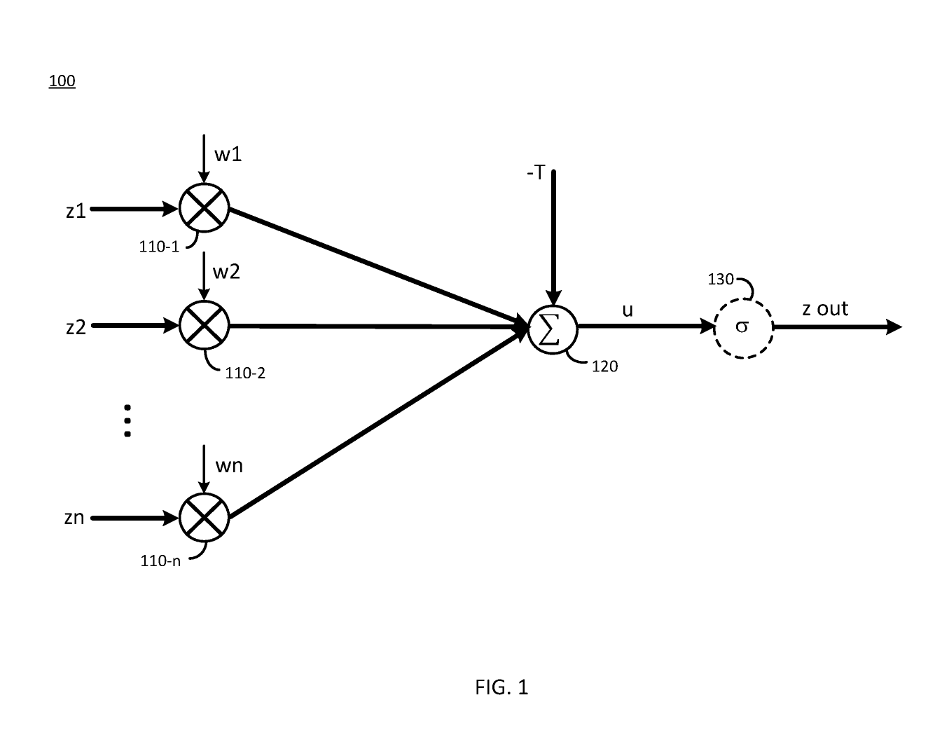

FIG. 1 illustrates a functional block diagram of a four stable state neuron 100 consistent with several embodiments of the present disclosure. Four stable state neuron 100 may include a plurality of input elements 110-1, 110-2, . . . , 110-n. Each input element 110-1, 110-2, . . . , 110-n has four stable states and is configured to receive a respective two-dimensional input signal z1, z2, . . . , zn and a respective weight w1, w2, . . . , wn. Each input element 110-1, 110-2, . . . , 110-n is configured to scale, i.e., multiply, a respective two-dimensional input signal z1, z2, . . . , zn by the respective weight w1, w2, . . . , wn. In an embodiment, weights w1, w2, . . . , wn may be scalars configured to scale both dimensions of each respective input signal z1, z2, . . . , zn. In another embodiment weights w1, w2, . . . , wn may be two-dimensional vectors configured to scale respective dimensions of each input signal z1, z2, . . . , zn.

Each dimension of each two-dimensional input signal z1, z2, . . . , zn may have two states. For example, each dimension may be represented as ±î and ±ĵ, respectively, where î and ĵ are orthogonal unit vectors and the states associated with each dimension are plus 1 or minus 1. Each dimension may correspond to a respective species, i.e., orientation, of spin current. The unit vectors may thus represent respective orientations of spin currents and/or saturation states of four stable state magnets, as described herein. The weights w1, w2, . . . , wn may be scalars, i.e., one value per input element 110-1, 110-2, . . . , 110-n, or may be two-dimensional vectors, i.e., one value per dimension.

Four stable state neuron 100 further includes an output element 120. The output element 120 is configured to receive outputs of the input elements 110-1, 110-2, . . . , 110-n, i.e., weighted input signals w1*z1, w2*z2, . . . , wn*zn. For scalar weights, “*” represents multiplication of each component (i.e., each dimension) of the associated input signal by the scalar weight. For vector weights, “*” represents multiplication of each component of the associated input signal by a respective value of the weight vector, i.e., a first dimension of the input signal multiplied by a first dimension of the weight vector and a second dimension of the input signal multiplied by a second dimension of the weight vector. The output element 120 is further configured to receive a threshold value, minus T. Similar to weights w1, w2, . . . , wn, the threshold -T may be a scalar or a two-dimensional vector. A two-dimensional threshold may be implemented by injecting spin current using two magnets with an easy axis of each magnet oriented in the î and ĵ directions, respectively. For example, the output element 120 may be a summing junction. An output, u, of summing junction 120 may then be u32 (Σᵢ₌₁ⁿwᵢ*zᵢ)−T. Four stable state neuron 100 is configured to provide a two-dimensional output signal, u, related to the input signals z1, z2, . . . , zn, weights w1, w2, . . . , wn and the threshold value −T. For example, each input element 110-1, 110-2, . . . , 110-n may correspond to a four stable state magnet and the output element 120 may correspond to a four stable state magnet, as described herein.

In some embodiments, four stable state neuron 100 may further include a thresholding stage 130 configured to implement an activation function. For example, the activation function may include, but is not limited to, a linear function, a step function and/or a sigmoid function. The thresholding stage 130 is configured to receive the output u from output element 120 and to provide zout. In other words, zout =f(u) where f(*) is the activation function. For example, the thresholding stage may be configured to implement a two-dimensional sigmoid function, e.g., 1/(1+e^{-(ux+uy)}) where ux and uy correspond to respective magnitudes of each dimension (i.e., each orientation of spin current) of the weighted sums, i.e., u=îux+ôuy. Each dimension corresponds to î or ĵ, respectively. A sigmoid function is configured to provide a bounded output, e.g., between zero and one, for weighted inputs in the range minus infinity to plus infinity. The sigmoid function may be utilized, for example, during training to determine the weights w1, w2, . . . , wn using a back propagation technique, as described herein.

Thus, a four stable state neuron may be configured to receive a plurality of two-dimensional input signals, to scale each received input signal, to sum the weighted input signals and threshold-detect the result. The four stable state neuron may be further configured to provide a two dimensional output signal.

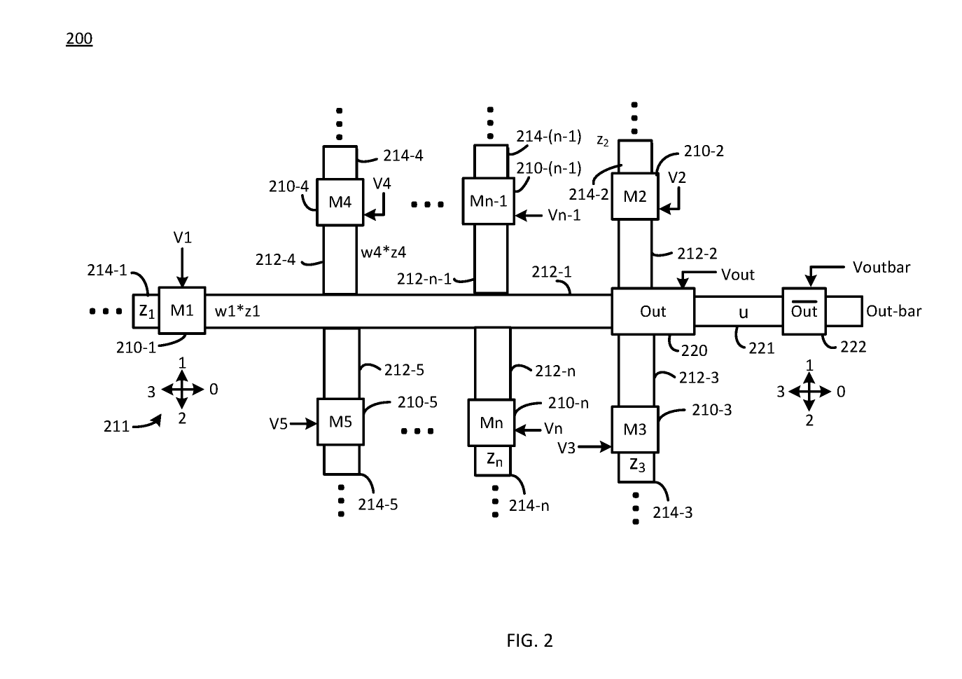

FIG. 2 illustrates a functional block diagram 200 of one example four stable state neuron including a plurality of four stable state magnets consistent with one embodiment of the present disclosure. Example 200 includes a plurality of input four stable state magnets 210-1, 210-2, . . . , 210-n and an output four stable state magnet 220 coupled by three coupling channels 212-1, 212-2, 212-3. In some embodiments, example 200 may further include an inverting output four stable state magnet 222 configured to provide an inverted output Out-bar.

Each four stable state magnet, e.g., four stable state magnet 210-1, is configured to have four stable states, i.e., four saturation states. Each stable state corresponds to a respective easy axis. The easy axes are illustrated by symbol 211. In the symbol 211, the easy axes are labeled counterclockwise as 0, 1, 3, 2. For example, axis 0 may correspond to +î axis 1 may correspond to +ĵ, axis 3 may correspond to −î and axis 2 may correspond to −ĵ. Thus, a first dimension of the four stable state magnet 210-1 may include two stable states represented by axes 0 and 3 and a second dimension of the four stable state magnet 210-1 may include two stable states represented by axes 1 and 2. Each dimension may correspond to a dimension of a corresponding spin current.

Each input four stable state magnet 210-1, 210-2, . . . , 210-n is coupled to a respective input channel 214-1, 214-2, . . . , 214-n. A subset of the plurality of input four stable state magnets, e.g., first input magnet 210-1 and input magnets 210-4, 210-5, . . . , 210-(n−1), 210-n, are coupled to a first coupling channel 212-1. The first coupling channel 212-1 may be configured to provide summing operations for weighted input signals from the subset of magnets coupled to the channel 212-1, as described herein. The second input magnet 210-2 is coupled to a second coupling channel 212-2. The third input magnet 210-3 is coupled to a third coupling channel 212-3. The first coupling channel 212-1, second coupling channel 212-2 and third coupling channel 212-3 are thus coupled between the input four stable state magnets 210-1, 210-2, . . . , 210-n and the output four stable state magnet 220.

The input four stable state magnets 210-1, 210-2, . . . , 210-n are configured to receive respective two-dimensional input signals z1, z2, . . . , zn via respective input channels 214-1, 214-2, . . . , 214-n. Each four stable state magnet 210-1, 210-2, . . . , 210-n, 220, 222 is configured to receive a respective supply voltage V1, V2, . . . , Vn, Vout, Vout-bar. The input four stable state magnets 210-1, 210-2, . . . , 210-n are configured to scale, i.e., multiply, each two-dimensional input signal z1, z2, . . . , zn by a respective weight w1, w2, . . . , wn. Each weight w1, w2, . . . , wn may correspond to a respective supply voltage V1, V2, . . . , Vn. For example, weight w1 may correspond to supply voltage V1, weight w2 may correspond to supply voltage V2, etc. In some embodiments, the weights and corresponding supply voltages may be two dimensional vectors that have two corresponding values, one value for each dimension of a four stable state magnet and, thus, for each spin current species. The respective supply voltages V1, V2, . . . , Vn are configured to modulate the respective input magnets 210-1, . . . , 210-n, and, thus scale the respective input signals, i.e., spin currents, received by the input magnets 210-1, . . . , 210-n. The scaled, i.e., weighted, spin currents may then be conducted to the output four stable state magnet 220 by coupling channels 212-1, 212-2, 212-3.

The subset of weighted input signals output from the subset of input magnets, i.e., output from first input magnet 210-1 and input magnets 210-4, 210-5, . . . , 210-(n−1), 210-n, may be summed in the first input channel 212-1. The sum of the subset of weighted input signals (i.e., w1*z1+Σᵢ₌₄ⁿwᵢ*zᵢ) and weighted input signals (i.e., w2*z2 and w3*z3) from the second input magnet 210-2 and the third input magnet 210-3 may be summed by the output magnet 220. Supply voltage Vout may modulate output magnet 220 and may thus modulate the magnitudes of each dimension of the sum of weighted input signals, Σᵢ₌₁ⁿwᵢ*zᵢ. The output magnet 220 may be further configured to receive a threshold value, −T. The threshold value, −T, may be one-dimensional or two-dimensional and may be summed with the weighted input signals, w1*z1, w2*z2, . . . , wn*zn, thus, the output signal, u, from output four stable state magnet 200 may be u=(Σᵢ₌₁ⁿwᵢ*zᵢ)−T. The threshold value, −T, is configured to manage whether the four stable state neuron 200 provides an output signal or not in response to the received input signals and based, at least in part, on the respective weights.

In some embodiments, the four stable state neuron 200 may further include an inverted output, Out-bar. In these embodiments, the output magnet 220 may be coupled to an inverting output magnet 222 by output channel 221. The inverting output magnet 222 is configured to receive an inverting supply voltage, Vout-bar. For example, a positive supply voltage may result in an inverted output for a four stable state magnet, e.g., four stable state magnet 222. The inverting output magnet 222 may be configured to invert one dimension or two dimensions of the output signal, u, from output magnet 220. As used herein, “inverting” includes changing state in one dimension or changing dimension. For example, an output signal, u, that includes a state that corresponds to the first dimension, +î, may be inverted to −î, i.e., may remain in the first dimension. In another example, an output signal, u, that includes a state that corresponds to the first dimension, e.g., +î, may be inverted to the second dimension, e.g., −ĵ or +ĵ. In this example, the inverting may be understood as a half order bar.

Thus, a four stable state (i.e., two dimensions, two states per dimension) neuron may be implemented by a plurality of four stable state magnets coupled by a plurality of channels. Input magnets are configured to weight, i.e., scale, received two-dimensional input signals that may contain a plurality of spin currents. An output magnet is configured to sum the weighted two-dimensional input signals and a threshold value. The threshold value may be a scalar or a vector. The four stable state neuron may then be configured to provide a two-dimensional output signal that may include two species of spin currents, if the weighted sum is greater than one or both dimensions of a two-dimensional threshold.

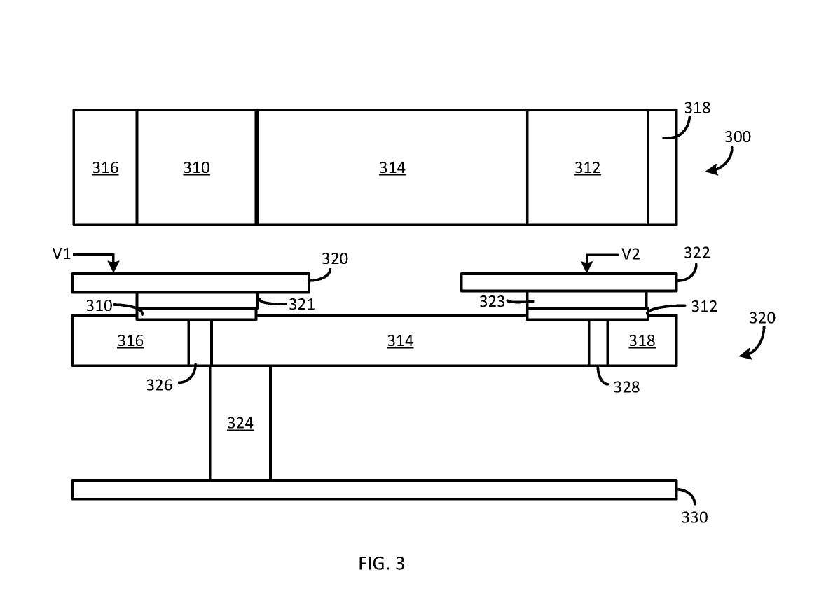

FIG. 3 illustrates a top view 300 and a side view 320 of a four stable state magnet assembly consistent with one embodiment of the present disclosure. The top view 300 is at the layer of the magnets, i.e., below the supply voltage trace layer, as described herein. The top view 300 illustrates a first 310 and a second 312 four stable state magnet coupled by a coupling channel 314. The first four stable state magnet 310 is coupled to an input channel 316. The second four stable state magnet 312, is coupled to a second channel 318. For example, the first four stable state magnet 310 may correspond to an input magnet, e.g., input magnet 210-1 of FIG. 2, and the second four stable state magnet 312 may correspond to an output magnet, e.g., output magnet 220. Continuing with this example, the second channel 318 may then correspond to an output channel, e.g., output channel 221.

The side view 320 of the four stable state magnet assembly illustrates the first 310 and the second 312 four stable state magnets and further illustrates channels 314, 316, 318. The first four stable state magnet 310 is coupled to a first supply voltage trace 320 and, thus a first supply voltage, V1, by a first coupling trace 321. The second four stable state magnet 312 is coupled to a second supply voltage trace 322 and, thus a second supply voltage, V2, by a second coupling trace 323. The input channel 316 and the coupling channel 314 may be separated by a first spacer 326. The coupling channel 314 and the second channel 318 may be separated by a second spacer 328. The coupling channel 314 is coupled to a ground plane 330 by a ground lead 324.

The four stable state magnets 310, 312 may be cubic magnetic crystalline anisotropy magnets. The four stable state magnets 310, 312 may be configured with two easy axes that are substantially (e.g., within ±six degrees) perpendicular to each other. The two easy axes may be achieved by combining shape and exchange coupling. The four stable state magnets 310, 312 may be ferromagnetic (i.e., voltage controlled). For example, the four stable state magnets 310, 312 may contain one or more of Co (Cobalt), Fe (Iron), Ni (Nickel) and/or alloys thereof and/or Huesler alloys of the form X2YZ. X,Y can take any element from 3d and 4d series. Z can be Si (Silicon), Ge (Germanium), Ga (Gallium), Al (Aluminum).

The channels 314, 316, 318 may correspond to spin channels configured to carry, i.e., conduct, one or more spin currents. The spin currents may each correspond to one or more species related to orientation of the spin, i.e., spin axis. For example, two spin axes may be substantially perpendicular Channels 314, 316, 318 may be formed of one or more relatively high spin diffusion length materials. For example, relatively high spin diffusion length materials may include, but are not limited to, copper, silver, aluminum and/or graphene (a two-dimensional relatively high spin diffusion material).

In operation, the four stable state magnets 310, 312 are configured to create spin polarized population densities, i.e., spin currents, underneath the magnets and to set up spin diffusion currents in the coupling channel 314. Spin polarization is related to spin axis and orientation of spin polarization may be related to orientation of the magnetic easy axes. The spin diffusion currents may be related to differing concentrations of respective species of spin currents in the channel near the respective four stable magnets 310, 312. In other words, higher density species of spin currents may flow, i.e., diffuse, toward regions with relatively lesser density spin current for that species. The direction of the spin diffusion current may be related to relative strengths of the spin polarizations of the carriers. For example, for a ground lead, e.g., ground lead 324, positioned relatively closer to an input magnet, e.g., first magnet 310, the input magnet, may act as a fixed magnetic terminal and the second magnet, e.g., magnet 312, may respond to the spin diffused beneath it. A magnitude of the response is related to the supply voltages V1, V2. For example, a positive supply voltage may yield an inverted output. In another example, a negative supply voltage may result in a non-inverted output.

Thus, top view 300 and side view 320 illustrate one example of a four stable state magnet assembly that may be utilized to implement a four stable state neuron, as described herein.

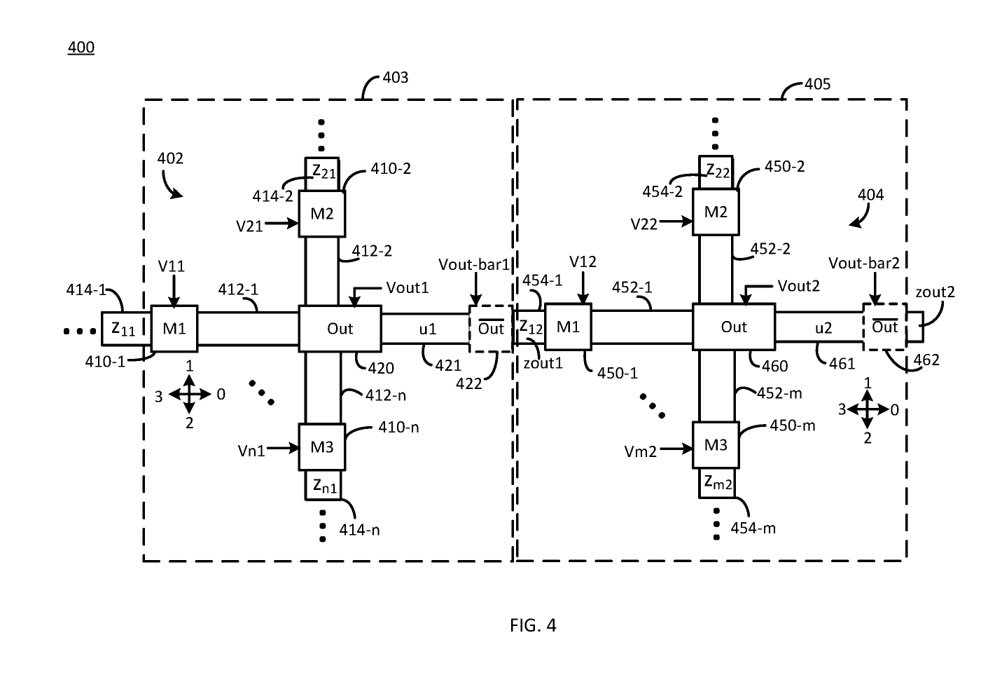

FIG. 4 illustrates a neural network portion 400 that includes two interconnected example four stable state neurons 402, 404 consistent with one embodiment of the present disclosure. Four stable state neuron 402 may be included in a first layer 403 and four stable state neuron 404 may be included in a second layer 405 of a neural network. A plurality of neurons may be electrically coupled to an output of a four stable state neuron.

Each four stable state neuron 402, 404 includes a respective plurality of input magnets 410-1, 410-2, . . . , 410-n and 450-1, 450-2, . . . , 450-m. Each input magnet 410-1, 410-2, . . . , 410-n and 450-1, 450-2, . . . , 450-m is coupled to a respective input channel 414-1, 414-2, . . . , 414-n and 454-1, 454-2, . . . , 454-m and respective supply voltage V11, V12, . . . , Vn1, and V12, V22, . . . , Vm2. Each input magnet 410-1, 410-2, . . . , 410-n and 450-1, 450-2, . . . , 450-m is configured to receive a respective input signal, e.g., two dimensional spin currents, z11, z21, . . . , zn1 and z12, z22, . . . , z2m, via the respective input channel 414-1, 414-2, . . . , 414-n and 454-1, 454-2, . . . , 454-m. Each input signal z11, z21, . . . , zn1 and z12, z22, . . . , z2m may include at least one spin current that corresponds to at least one stable state, as described herein. Each input magnet of the first plurality of input magnets 410-1, 410-2, . . . , 410-n is coupled to a first output magnet 420 by a respective coupling channel 412-1, 412-2, . . . , 412-n and each input magnet of the second plurality of input magnets 450-1, 450-2, . . . , 450-m is coupled to a second output magnet 460 by a respective coupling channel 452-1, 452-2, . . . , 452-m. Each output magnet 420, 460 is coupled to a respective supply voltage Vout1, Vout2.

In an embodiment, the first four stable state neuron 402 may not include an inverted output (e.g., Zout1) and the second four stable state neuron 404 may not include an inverted output (e.g., Zout2). In this embodiment, the first output magnet 420 is coupled to input magnet 450-1 via a first output channel 421. The first output channel 421 may be further coupled to one or more other four stable state neurons included in the second layer 405. The second output magnet 460 is coupled to a second output channel 461. The second output channel 461 may be coupled to a neural network output, e.g., an input to a computing device, and/or one or more other four stable state neurons (not shown). Thus, a two-dimensional output signal u1 of the first four stable state neuron 402 may correspond to a two-dimensional input signal z12 of the second four stable state neuron 404. A two-dimensional output signal of the second four stable state neuron may then correspond to u2.

In another embodiment, the first four stable state neuron 402 may include a first inverted output four stable state magnet 422 coupled to a first inverted supply voltage, Vout-bar1. The second four stable state neuron 404 may include a second inverted output four stable state magnet 462 coupled to a second inverted supply voltage, Vout-bar2. In this embodiment, the first output magnet 420 is coupled to the inverted output magnet 422 via the first output channel 421. The inverted output magnet 422 may then be coupled to input magnet 450-1 of the second four stable state neuron 404 by input channel 454-1. The second inverted output magnet 462 may be coupled to a neural network output and/or another four stable state neuron (not shown). In this embodiment, u1 is inverted to yield zout1 that then corresponds to an input signal to input magnet 450-1. Similarly, u2 is inverted to yield zout2. zout1 and/or zout2 may be provided to one or more other four stable state neurons by channels coupled to respective inverted output four stable state magnets 422, 462.

In operation, each input magnet 410-1, 410-2, . . . , 410-n and 450-1, 450-2, . . . , 450-m is configured to scale a respective input signal z11, z21, . . . , zn1 and z12, z22, . . . , z2m by a respective weight w11, w12, . . . , wn1 and w21, w22, . . . , wm2 that corresponds to respective supply voltage V11, V12, . . . , Vn1 and V21, V22, . . . , Vm2. The scaled, i.e., weighted, input signals (e.g., w11*z11, w12*z12, . . . ) may then be provided to the output magnets 420, 460 where they may be summed and thresholded. A corresponding output signal may then be provided to a neural network output (and to, e.g., a computing device) and/or one or more subsequent four stable state neurons.

FIG. 5 illustrates a functional block diagram 500 of a system consistent with several embodiments of the present disclosure. System 500 includes a computing device 502 coupled to an artificial neural network 504. System 500 may further include a voltage supply 550 coupled to artificial neural network 504. Voltage supply 500 is configured to provide one or more supply voltages to artificial neural network 504 and to one or more four stable state neurons, as described herein.

Artificial neural network 504 may include a plurality of four stable state neurons, as described herein. The plurality of four stable state neurons may be coupled in one or more layers and each layer may include one or more four stable state neurons. Each four stable state neuron may be coupled to one or more neurons at one or more inputs. Each four stable state neuron may be further coupled to one or more neurons at one or more outputs. The interconnections may be serial (i.e., layers), parallel (i.e., per layer) and/or combinations thereof. Thus, connectivity between the plurality of four stable state neurons may range from single layer-single neuron to a plurality of interconnected layers with a plurality of neurons included in each layer.

Computing device 502 is configured to manage determining respective weights associated with each input to each four stable state neuron included in neural network 504. Computing device 502 is further configured to manage operation of neural network 504 to determine an output based on input data set, as described herein. Computing device 502, may include, but is not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; a computing system (e.g., a server, a workstation computer, a desktop computer, a laptop computer, a tablet computer (e.g., iPad®, GalaxyTab® and the like), an u1traportable computer, an u1tramobile computer, a netbook computer and/or a subnotebook computer; etc.

Computing device 502 includes a processor 510, memory 512 and peripheral devices 514. Computing device 502 further includes neural network controller logic 520 and weight determination logic 522. In an embodiment, weight determination logic 522 may be included in neural network controller logic 520. In another embodiment, weight determination logic 522 may be coupled to neural network controller logic 520. Computing device 502 may further include training information, e.g., training parameters 530, training input data 532 and training output data 534. Computing device 502 may further include neural network output data 540, coefficient data 542 and/or data set 544. In some embodiments, computing device 502 may include neural network interface 524.

Processor 510 is configured to perform operations of computing device 502. Memory 512 may be configured to store training information, 530, 532 and/or 534, neural network output data 540, coefficient data 542 and/or data set 544. For example, data contained in data set 544 may include, but is not limited to, data related to pattern recognition, classification, regression analysis, etc. Peripheral devices 514 may include, but are not limited to, a user interface (e.g., a key pad, keyboard, touch pad, mouse, display, touch sensitive display), one or more sensor(s) (e.g., an accelerometer, global positioning system (GPS), gyroscope, etc.), storage device(s) (e.g., hard disk drive, solid state drive, etc.), etc.

Neural network interface 524 is configured to provide an interface between artificial neural network 504 and computing device 502. Neural network interface 524 may be configured to convert raw neural network output data, e.g., spin currents, to an analog electrical signal and/or a corresponding digital representation. For example, neural network interface 524 may include tunneling magnetoresistance (TMR) and/or giant magnetoresistance (GMR) circuitry. In another example neural network interface 524 may include inverse spin orbit effect (Rashba) circuitry. Neural network interface 524 may be further configured to convert an analog electrical signal and/or digital data to spin currents. The digital data may be converted to an analog voltage or current applied on/through a nanomagnet. In other words, current may be injected via a magnet.

Neural network controller logic 520 is configured to manage operation of artificial neural network 504 and to control voltage supply 550. In some embodiments, artificial neural network 504 may be trained, i.e., weights may be determined, initially, prior to processing a data set. In some embodiments, the weights may be determined utilizing the data set and the weights may then correspond to a processing result. Training parameters 530 are configured to include parameter values associated with training and/or determining weights. For example, training parameters 530 may include initial weight values, a maximum number of iterations, a range of target error values, etc.

For example, supervised learning may include training to determine weights. Supervised learning includes providing training input data, e.g., training input data 532, to artificial neural network 504 and capturing neural network output data, e.g., neural network output data 540. The neural network output data 540 may then be compared to training output data 534 that corresponds to training input data 532. The weights, e.g., coefficient data 542, may be adjusted based, at least in part, on the comparison. For example, weight determination logic 522 may be configured to adjust the weights and to repeat providing training input data 532, capturing neural network output data 540 and comparing the captured neural network output data 540 to the training output data 534. These operations may be repeated until an error between the training output data 534 and the captured neural network output data 540 is less than or equal to a target value. Coefficient data 542 may then be configured to store the weights associated with the neural network output data 540 that was within the target value of the training output data 534.

In another example, unsupervised learning may be configured to determine weights based, at least in part, on a data set, e.g., data set 544. Unsupervised learning includes providing input data, e.g., data set 544, to artificial neural network 504 and capturing neural network output data, e.g., neural network output data 540. An incremental weight, Δw, may then be determined based, at least in part, on the input data and based, at least in part, on the captured output data. The weights, e.g., coefficient data 542, may be adjusted based, at least in part, on the incremental weight. For example, weight determination logic 522 may be configured to determine the incremental weight, to adjust the weights and to repeat providing input data from data set 544, capturing neural network output data 540 and determining the incremental weight. These operations may be repeated until a difference between the a prior incremental weight and a current incremental weight is less than or equal to a threshold value. Coefficient data 542 may then be configured to store the weights associated with the incremental weights that were less than or equal to the threshold value.

The weights may be determined using one or more techniques. The techniques may include, but are not limited to, back propagation, Delta rule, Oja ruled-based Hebbian analysis and/or principal components analysis. Determining the weights may further utilize gradient descent techniques configured to determine a local minimum (or maximum) for a function, e.g., an error function.

After the neural network 504 has been trained (i.e., supervised learning) or during unsupervised learning, data set 544 may be provided to artificial neural network 504 by, e.g., neural network controller logic 520. Weights associated with artificial neural network 504 may be implemented by configuring voltage supply 550 to provide appropriate supply voltage and coupling the appropriate supply voltages to neural network 504, as described herein. Neural network output data 540 may then be captured by, e.g., neural network controller logic 520, and a corresponding output may be provided to a user via peripheral devices 514.

Thus, in some embodiments, artificial neural network 504 may be trained, i.e., weights may be determined, initially, prior to processing a data set. In some embodiments, the weights may be determined utilizing the data set and the weights may then correspond to a processing result.

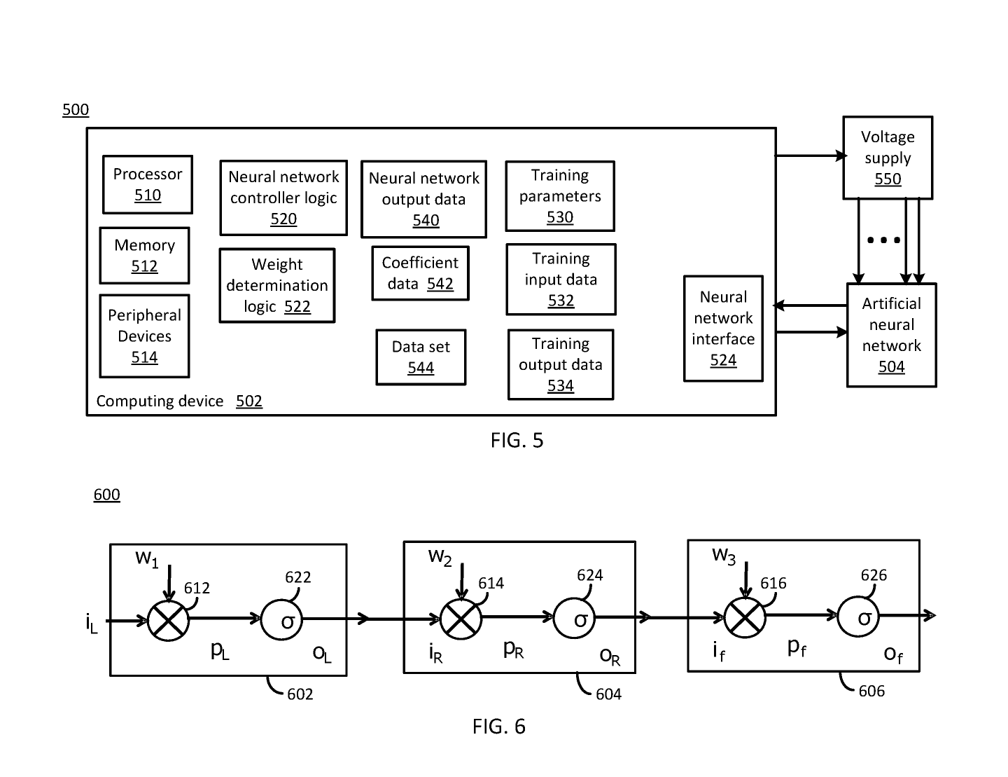

FIG. 6 illustrates a functional block diagram 600 of a feedforward neural network related to a back propagation technique. Back propagation is one example technique for supervised training of an artificial neural network. In other words, back propagation may be used, in combination with an optimization method, e.g., gradient descent, to determine weights, wᵢ, as described herein. Back propagation may be considered a generalization of the Delta rule to multilayered feedforward (i.e., without feedback loops) networks. A constraint of the back propagation technique is that the activation function be differentiable. An example of a differentiable activation function is the sigmoid function. For example, a two-dimensional sigmoid function may be written as:

$$σ = \frac{1}{1 + {e}^{- ( ux + uy )}}$$

where x and y correspond to respective magnitudes of each dimension of the weighted sums output from a summing junction, e.g., summing junction 120 of FIG. 1. In another example, the two-dimensional sigmoid function may be written as:

$$σ = \frac{1}{1 + {e}^{- ( \vert ux \hat{i} \vert + \vert uy \hat{j} \vert )}}$$

In this example, the two-dimensional aspect of the input signals and the input elements, e.g., four stable state magnets, is explicit with the inclusion of the unit vectors. Assuming that the two dimensions, î and ĵ, are independent, the first derivatives of the sigmoid function may be written as:

$$\frac{d σ}{dx} = σ ( 1 - σ )$$

$$and$$

$$\frac{d σ}{dy} = σ ( 1 - σ )$$

In other words, the sigmoid function is differentiable.

Feedforward neural network 600 includes an input four stable state neuron 602 coupled to a hidden four stable state neuron 604 coupled to an output four stable state neuron 606. In a layer structure, the input four stable state neuron 602 may be included in an input layer, the hidden four stable state neuron 604 may be included in a hidden layer and the output four stable state neuron 606 may be included in an output layer. The input four stable state neuron 602 includes an input element 612, e.g., a four stable state magnet, configured to receive a first weight, w1, coupled to a thresholding stage 622. The hidden four stable state neuron 604 includes an input element 614, e.g., a four stable state magnet, configured to receive a second weight, w2, coupled to a thresholding stage 624. The output four stable state neuron 606 includes an input element 616, e.g., a four stable state magnet, configured to receive a third weight, w3, coupled to a thresholding stage 626. Each weight w1, w2, w3, may be related to a respective supply voltage, as described herein.

Generally, the back propagation technique may be applied to feedforward neural networks that include a plurality of neurons in each layer and/or that include a plurality of hidden layers coupled between the input layer and the output layer. As a supervised learning technique, a known input signal, i_{L}, and a corresponding desired output, t_{f}, is provided to the neural network. Back propagation is configured to determine the weights w1, w2 and w3 that minimize an error, E, between the desired output, t_{f}, and the actual output, O_{f}. Initially, weights w1, w2 and w3 may be set to random values. The input signal, i_{L}, may then be applied to the input layer 602 and may process through the hidden layer 604 to the output, O_{f}, of the output layer 606. The error may be determined as:

E=−1/2(t_{f}−o_{f})²

A first order partial differential of the error with respect to an output weight, e.g., w3, for the output layer may be written as:

$$\frac{\partial E}{\partial {w}_{f}} = {δ}_{f} {i}_{f}$$

where w3 corresponds to w_{f}. The first order partial differential of the error with respect to each weight (e.g., w1, w2) may be written as:

$$\frac{\partial E}{\partial {w}_{i}} = {δ}_{i} {i}_{i}$$

for any other layer. The delta coefficients may then be defined as:

δ_{f}=o_{f}(1−o_{f})(t_{f}−o_{f})

for the output layer and

δᵢ=oᵢ(1−oᵢ)δᵢ₊₁wᵢ₊₁

for any other layer. The gradient descent may then be utilized to determine a new weight, wᵢ(new), for each layer (i=1, 2, 3) based, at least in part, on an old weight, wᵢ(old), and a based, at least in part, on the delta coefficients as:

$${w}_{i} ( new ) = {w}_{i} ( old ) - η \frac{\partial E}{{w}_{i}} .$$

The factor, η, is related to speed and accuracy for the gradient descent. For example, a relatively larger value of η may result in a relatively faster convergence but may yield a relatively less accurate result compared to a relatively smaller value of η.

Thus, in operation, for each value of input signal, i_{L}, the output layer delta coefficient may be determined, the hidden layer delta coefficients may be determined, the input layer delta coefficient may be determined and then the new weights may be determined for each layer. The process may be repeated, iteratively, until the error is less than or equal to a target error value. It may be appreciated that for an input layer and/or hidden layers that include a plurality of four stable state neurons, the delta coefficients, δᵢ, are determined utilizing a sum of the products, δᵢ₊₁wᵢ₊₁, for each neuron in the adjacent subsequent layer.

Thus, it is contemplated that the back propagation technique may be utilized in a supervised learning process to determine the respective weight(s) associated with each input four stable state neuron. For example, the output signal, u, and each input signal, zᵢ, may each be two dimensional vectors. In an embodiment, the weight, wᵢ, may be a two-dimensional vector. In another embodiment, the weight, wᵢ, may be a scalar. A corresponding supply voltage value may then be determined and/or adjusted based, at least in part, on the respective weight.

The delta rule is another supervised learning technique for determining weights. Similar to the back propagation technique, the delta rule also utilizes gradient descent for updating the weights. The delta rule is a special case of the back propagation technique configured to determine the weights for a single layer artificial neural network. The single layer may contain a plurality of four stable state neurons and may have one or more inputs and one or more outputs.

The delta rule is configured to provide an incremental value for adjusting a respective weight, iteratively, for each four stable state neuron included in the single layer. For example, the incremental weight adjustment value may be written as:

δwⱼᵢ=α(tⱼ−zoutⱼ)g′(uⱼ)zᵢ

where j is an index that corresponds to the j^{th} neuron, i is an index that corresponds to the i^{th} input, Δwⱼᵢ is the incremental weight adjustment value for the j^{th} neuron and the i^{th} input, α is a constant related to learning rate, g(*) is the neuron's activation function, tᵢ is the target output, uᵢ is the weighted sum of the neuron's inputs, zoutⱼ is the actual output and zᵢ is the i^{th} input. In other words, uⱼ=Σzᵢwⱼᵢ and zoutⱼ=g(uⱼ).

Thus, it is contemplated that the delta rule may be utilized in a supervised learning process to determine the respective weight(s) associated with each input four stable state neuron. For example, the output signal, u, and each input signal, zᵢ, may each be two dimensional vectors. In an embodiment, the weight, wᵢ, may be a two-dimensional vector. In another embodiment, the weight, wᵢ, may be a scalar. A corresponding supply voltage value may then be determined and/or adjusted based, at least in part, on the respective weight.

Hebbian learning is one example of unsupervised learning configured to determine weights associated with connections between neurons, i.e., the weights associated with input four stable state neurons, as described herein. In the Hebbian technique, a strength of a connection, i.e., weight, is related to pre-and post-synaptic neural activities. In other words, the weight of a connection is related to an input signal and an output signal for a target neuron. Hebbian learning may be modified by Oja's rule to address instability associated with Hebbian learning. Thus, the incremental weight adjustment, Δwᵢ, for Hebbian learning modified by Oja's rule may be written as:

Δwᵢ=α(zᵢu−u²wᵢ)

where α is a factor related to accuracy and speed of convergence, similar to η, as described herein, zᵢis the input signal and u is the output signal. A neuron model, i.e., a relationship between the output signal and the input signals may be written as:

$$u = {\sum }_{i = 1}^{n} {w}_{i} {z}_{i}$$

The neuron model and incremental weight adjustment relationship may be written in matrix form as:

u= [symbol] ^{T} [symbol] = [symbol] ^{T}

[symbol]

and

Δ [symbol] =α( [symbol] u−u² [symbol] )

respectively, where the arrow accent indicates matrix or vector, w corresponds to weights and the z corresponds to input signals.

Principal component analysis of a data set is configured to determine and/or identify a direction that corresponds to a maximum or a minimum variance in a data set. The direction, q, may then correspond to an eigenvector of a correlation matrix and the correlation matrix corresponds to expectation of covariance. It may be appreciated that weights determined for a neuron using Hebbian learning modified by Oja's rule correspond to principal components. In other words, the final weights may correspond to eigenvectors of a covariance matrix.

In equation form, R [symbol] =λ [symbol] , where R corresponds to correlation matrix, R=E[zz^{T}], where E is expectation, and C=E[R], where C corresponds to covariance. It can be shown that C\vec{w}= [symbol] ^{T}C\vec{w}\vec{w}, where w is a vector of weights, and that R\vec{w}=(\vec{w}^{T} R\vec{w})\vec{w}. Thus, weights determined using Hebbian learning modified by Oja's rule may correspond to eigenvectors associated with principal component analysis.

It is contemplated that Hebbian learning modified by Oja's rule may be implemented by a four stable state neuron consistent with the present disclosure. For example, the output signal, u, and each input signal, zᵢ, may each be two dimensional vectors. In an embodiment, the weight, wᵢ, may be a two-dimensional vector. In another embodiment, the weight, wᵢ, may be a scalar.

Thus, a four stable state neuron may be configured to determine and/or identify one or more principal components, i.e., eigenvectors, for a data set utilizing unsupervised learning, as described herein. In other words, weights determined utilizing Hebbian learning modified by Oja's rule may correspond to the eigenvectors.

Thus, a plurality of learning techniques may be applied to a four stable state neuron and/or a neural network that contains a plurality of four stable state neurons, as described herein. For example, gradient descent and/or PCA may be implemented via two-dimensional neural network theory that is a generalized form of one-dimensional neural network theory.

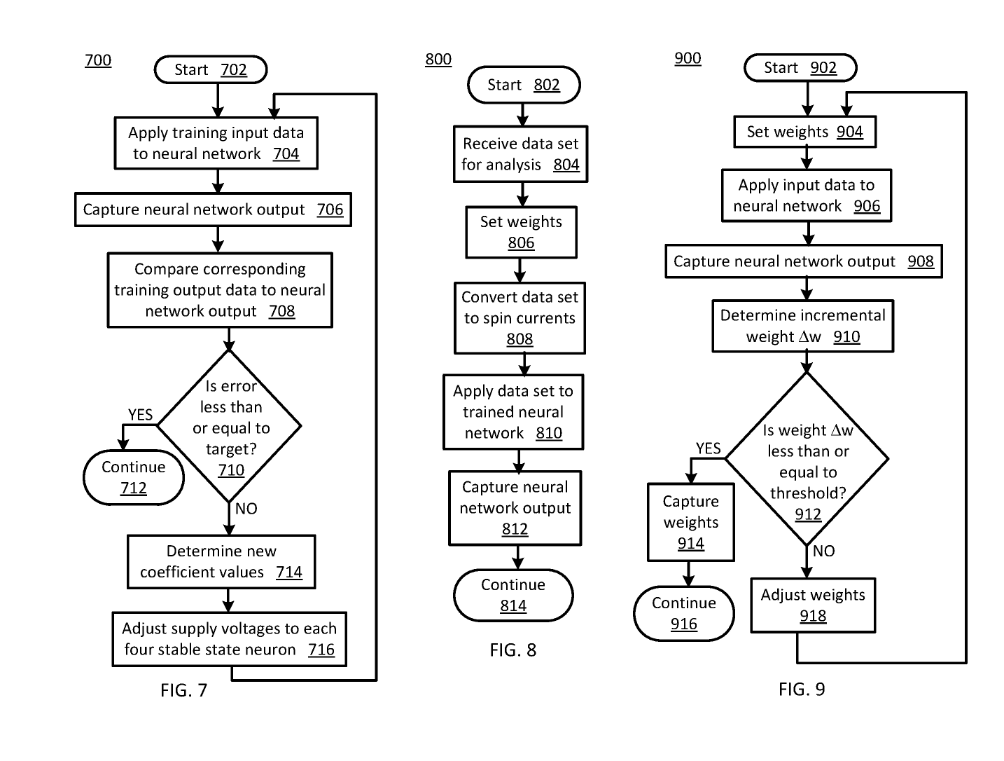

FIG. 7 is a flowchart 700 of supervised learning operations according to various embodiments of the present disclosure. In particular, the flowchart 700 illustrates determining weights for an artificial neural network that contains a plurality of four stable state neurons, as described herein. The operations may be performed, for example, by computing device 502, e.g., weight determination logic 522 and/or neural network controller logic 520 of FIG. 5.

Operations of this embodiment may begin with start 702. Operation 704 includes applying training input data to a neural network. For example, the neural network may include a plurality of four stable state neurons, as described herein. Neural network output may be captured at operation 706. Corresponding training output data may be compared to neural network output at operation 708. Whether an error is less than or equal to a target may be determined at operation 710. If the error is less than or equal to the target, program flow may continue at operation 712. If the error is not less than or equal to the target, new coefficient values may be determined at operation 714. Supply voltages to the four stable state neurons may be adjusted at operation 716. Program flow may then return to operation 704 applying training input data to the neural network.

Thus, weights may be determined based, at least in part, on training data. FIG. 8 is a flowchart 800 of neuromorphic computing operations according to various embodiments of the present disclosure. In particular, the flowchart 800 illustrates utilizing a trained neural network to process, e.g., analyze, a data set. For example, the trained neural network may include a plurality of four stable state neurons, as described herein. The operations may be performed, for example, by computing device 502, e.g., neural network interface 524 and neural network controller logic 520 of FIG. 5.

Operations of this embodiment may begin with start 802. A data set may be received for analysis at operation 804. Weights may be set at operation 806. For example, supply voltages to a plurality of four stable state magnets may be set based, at least in part, on coefficient data determined during training operations. The received data set may be converted to spin currents at operation 808. The data set may be applied to the trained neural network at operation 810. Neural network output data may be captured at operation 812. Program flow may continue at operation 814.

Thus, a trained neural network may be configured to analyze a data set.

FIG. 9 is a flowchart 900 of unsupervised learning operations according to various embodiments of the present disclosure. In particular, the flowchart 900 illustrates Hebbian learning modified by Oja's rule configured to identify a principal component for a data set. The operations may be performed, for example, by computing device 502, e.g., weight determination logic 522 and/or neural network controller logic 520 of FIG. 5.

Operations of this embodiment may begin with start 902. Weights may be set at operation 904. For example, weights may be set to random values, initially. Subsequent values may be set based, at least in part, on a determined incremental weight and based, at least in part, on a current weight value, as described herein. Input data may be applied to the neural network at operation 906. For example, the input data may include data from a data set, as described herein. Neural network output data may be captured at operation 908. An incremental weight may be determined at operation 910. Whether the incremental weight is less than or equal to a threshold value may be determined at operation 912. If the incremental weight is less than or equal to the threshold value, the weights may be captured at operation 914. Program flow may then continue in operation 916. If the incremental weight is not less than or equal to the threshold value, then the weights may be adjusted at operation 918. For example, the incremental weight may be added to (or subtracted from) each current weight to generate a respective new weight. Adjusting the weight may further include adjusting a supply voltage to a corresponding four stable state input magnet, as described herein. Program flow may then proceed to operation 904.

Thus, a neural network that includes a four stable state neuron may be configured to implement Hebbian learning modified by Oja's rule to identify a principal component for a data set.

While the flowcharts of FIGS. 7 through 9 illustrate operations according various embodiments, it is to be understood that not all of the operations depicted in FIGS. 7 through 9 are necessary for other embodiments. In addition, it is fully contemplated herein that in other embodiments of the present disclosure, the operations depicted in FIGS. 7, 8 and/or 9 and/or other operations described herein may be combined in a manner not specifically shown in any of the drawings, and such embodiments may include less or more operations than are illustrated in FIGS. 7 through 9 Thus, claims directed to features and/or operations that are not exactly shown in one drawing are deemed within the scope and content of the present disclosure.

Generally, this disclosure relates to a four stable state neuron. The four stable state neuron is configured to receive a plurality of two-dimensional input signals with each dimension having two stable states for a total of four states. The four stable state neuron is configured to determine a weighted sum of the input signals. Similar to the input signals, the weighted sum has two dimensions. The four stable state neuron is further configured to provide a two-dimensional output based, at least in part, on the weighted sum of the input signals and based, at least in part, on a threshold value. For example, the weighting of each input signal may be implemented by a respective input four stable state magnet and the summing may be implemented by an output four stable state magnet, as described herein. The states correspond to saturation states, i.e., easy axes of the four stable state magnet. The states further correspond to orientation of electron spin currents that may be modulated by the magnet(s). Thus, the four stable state neuron may receive a plurality of two-dimensional input signals and is configured to provide a two-dimensional output.

Thus, interconnects associated with four stable state neurons may be relatively less complex than interconnects configured to couple with binary neurons. Interconnects associated with four stable state neurons are configured to carry two-dimensional data with two states per dimension for a total of four states. In other words, rather than two interconnects configured to carry one dimension (and two states), one interconnect is configured to carry two-dimensions and four states thus, fewer interconnects for a same number of dimensions and/or states.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the present disclosure are possible. The processor may include one or more processor cores and may be configured to execute system software. System software may include, for example, an operating system. Device memory may include I/O memory buffers configured to store one or more data packets that are to be transmitted by, or received by, a network interface.

The operating system (OS) may be configured to manage system resources and control tasks that are run on, computing device 502. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units.

Memory 512 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE 1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog-Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a method, means for performing acts of the method, a device, or of an apparatus or system related to a four stable state neuron, as discussed below.

### Example 1

According to this example, there is provided a four stable state neuron. The four stable state neuron includes a plurality of input elements and a plurality of coupling channels. Each input element is coupled to a respective coupling channel and each input element is to scale a respective two-dimensional input signal by a weight. The four stable state neuron further includes a first output element coupled to the plurality of coupling channels. The first output element is to receive the plurality of weighted two-dimensional input signals and to generate a two-dimensional output signal based, at least in part, on a threshold value.

### Example 2

This example includes the elements of example 1, wherein a first dimension of each two-dimensional input signal corresponds to a first spin current having a first orientation and a second dimension of each two-dimensional input signal corresponds to a second spin current having a second orientation and the first output element is to sum the plurality of weighted first spin currents and a first threshold value and to sum the plurality of weighted second spin currents and a second threshold value to generate the two-dimensional output signal.

### Example 3

This example includes the elements of example 1, wherein each input element is an input four stable state magnet and the output element is an output four stable state magnet, each state corresponding to an easy axis of the respective magnet.

### Example 4

This example includes the elements of example 1, further comprising an inverting output element coupled to the first output element, the inverting output element to invert the two-dimensional output signal.

### Example 5

This example includes the elements of example 1, further comprising a thresholding stage to implement an activation function.

### Example 6

This example includes the elements of example 5, wherein the activation function is sigmoidal.

### Example 7

This example includes the elements of example 4, wherein the inverting output element is a four stable state magnet, each state corresponding to an easy axis of the magnet.

### Example 8

This example includes the elements according to any one of examples 1 through 5, wherein each weight is a two-dimensional vector.

### Example 9

This example includes the elements of example 2, wherein the first spin current is oriented substantially perpendicular to the second spin current.

### Example 10

According to this example, there is provided an artificial neural network. The artificial neural network includes a plurality of four stable state neurons. Each four stable state neuron includes a plurality of input elements and a plurality of coupling channels. Each input element is coupled to a respective coupling channel and each input element is to scale a respective two-dimensional input signal by a weight. Each four stable state neuron further includes a first output element coupled to the plurality of coupling channels. The first output element is to receive the plurality of weighted two-dimensional input signals and to generate a two-dimensional output signal based, at least in part, on a threshold value.

### Example 11

This example includes the elements of example 10, wherein a first dimension of each two-dimensional input signal corresponds to a first spin current having a first orientation and a second dimension of each two-dimensional input signal corresponds to a second spin current having a second orientation and the first output element is to sum the plurality of weighted first spin currents and a first threshold value and to sum the plurality of weighted second spin currents and a second threshold value to generate the two-dimensional output signal.

### Example 12

This example includes the elements of example 10, wherein each input element is an input four stable state magnet and the output element is an output four stable state magnet, each state corresponding to an easy axis of the respective magnet.

### Example 13

This example includes the elements of example 10, wherein at least one neuron further comprises an inverting output element coupled to the first output element, the inverting output element to invert the two-dimensional output signal.

### Example 14

This example includes the elements of example 10, wherein at least one neuron further comprises a thresholding stage to implement an activation function.

### Example 15

This example includes the elements of example 14, wherein the activation function is sigmoidal.

### Example 16

This example includes the elements of example 13, wherein the inverting output element is a four stable state magnet, each state corresponding to an easy axis of the magnet.

### Example 17

This example includes the elements according to any one of examples 10 through 14, wherein each weight is a two-dimensional vector.

### Example 18

This example includes the elements of example 11, wherein the first spin current is oriented substantially perpendicular to the second spin current.

### Example 19

This example includes the elements according to any one of examples 10 through 14, wherein the artificial neural network comprises a plurality of layers, each layer comprising at least one four stable state neuron.

### Example 20

According to this example, there is provided a system. The system includes a computing device and an artificial neural network coupled to the computing device. The computing device includes a processor and a memory. The artificial neural network includes a plurality of four stable state neurons. Each four stable state neuron includes a plurality of input elements and a plurality of coupling channels. Each input element is coupled to a respective coupling channel and each input element is to scale a respective two-dimensional input signal by a weight. Each four stable state neuron further includes a first output element coupled to the plurality of coupling channels. The first output element is to receive the plurality of weighted two-dimensional input signals and to generate a two-dimensional output signal based, at least in part, on a threshold value.

### Example 21

This example includes the elements of example 20, wherein a first dimension of each two-dimensional input signal corresponds to a first spin current having a first orientation and a second dimension of each two-dimensional input signal corresponds to a second spin current having a second orientation and the first output element is to sum the plurality of weighted first spin currents and a first threshold value and to sum the plurality of weighted second spin currents and a second threshold value to generate the two-dimensional output signal.

### Example 22

This example includes the elements of example 20, wherein each input element is an input four stable state magnet and the output element is an output four stable state magnet, each state corresponding to an easy axis of the respective magnet.

### Example 23

This example includes the elements of example 20, wherein at least one neuron further comprises an inverting output element coupled to the first output element, the inverting output element to invert the two-dimensional output signal.

### Example 24

This example includes the elements of example 20, wherein at least one neuron further comprises a thresholding stage to implement an activation function.

### Example 25

This example includes the elements according to any one of examples 20 through 24, wherein each weight is a two-dimensional vector.

### Example 26

This example includes the elements according to any one of examples 20 through 24, wherein the weights are determined using a back propagation technique.

### Example 27

This example includes the elements according to any one of examples 20 through 24, wherein the artificial neural network comprises a plurality of layers, each layer comprising at least one of the plurality of neurons.

### Example 28

This example includes the elements according to any one of examples 20 through 24, wherein the computing device further comprises a neural network interface to convert the spin currents to corresponding digital representations.

### Example 29

This example includes the elements according to any one of examples 20 through 24, further comprising a voltage supply to provide a plurality supply voltages to the artificial neural network, each supply voltage related to a respective weight.

### Example 30

This example includes the elements according to any one of examples 20 through 24, wherein the computing device further comprises weight determination logic to Determine the weight.

### Example 31

This example includes the elements of example 30, wherein the weight is determined using a supervised learning technique.

### Example 32

This example includes the elements of example 30, wherein the weight is determined using an unsupervised learning technique.

### Example 33

This example includes the elements of example 30, wherein the weight is determined using a gradient descent technique.

### Example 34

This example includes the elements of example 30, wherein the weight is determined using one or more of back propagation, gradient descent, delta rule, Oj a rule-based Hebbian analysis and/or principal components analysis.

### Example 35

This example includes the elements according to any one of examples 20 through 24, wherein the computing device further comprises neural network controller logic to manage operations of the artificial neural network.

### Example 36

According to this example, there is provided a method. The method includes receiving, by each input element of a plurality of input elements, a respective two-dimensional input signal; scaling, by each input element, the respective two-dimensional input signal by a weight; receiving, by a first output element, the plurality of weighted two-dimensional input signals; and generating, by the first output element, a two-dimensional output signal based, at least in part, on a threshold value.

### Example 37

This example includes the elements of example 36, wherein a first dimension5 of each two-dimensional input signal corresponds to a first spin current having a first orientation and a second dimension of each two-dimensional input signal corresponds to a second spin current having a second orientation and further comprising summing, by the first output element, the plurality of weighted first spin currents and a first threshold value and summing, by the first output element, the plurality of weighted second spin currents and a second threshold value, to generate the two-dimensional output signal.

### Example 38

This example includes the elements of example 36, wherein each input element is an input four stable state magnet and the output element is an output four stable state magnet, each state corresponding to an easy axis of the respective magnet.

### Example 39

This example includes the elements of example 36, further comprising inverting, by an inverting output element, the two-dimensional output signal, the inverting output element coupled to the first output element.

### Example 40

This example includes the elements of example 36, further comprising implementing, by a thresholding stage, an activation function.

### Example 41

This example includes the elements of example 36, wherein each weight is a two-dimensional vector.

### Example 42

This example includes the elements of example 36, further comprising converting, by a neural network interface, the spin currents to corresponding digital representations.

### Example 43

This example includes the elements of example 36, further comprising determining, by weight determination logic, each weight.

### Example 44

This example includes the elements of example 36, wherein each weight is determined using a supervised learning technique.

### Example 45

This example includes the elements of example 36, wherein each weight is determined using an unsupervised learning technique.

Example 46

This example includes the elements of example 36, wherein each weight is determined using one or more of back propagation, gradient descent, delta rule, Oj a rule-based Hebbian analysis and/or principal components analysis.

### Example 47

According to this example, there is provided a system. The system includes at least one device arranged to perform the method of any one of examples 36 to 46.

### Example 48

According to this example, there is provided a device. The device includes means to perform the method of any one of examples 36 to 46.

### Example 49

According to this example, there is provided a computer readable storage device. The computer readable storage device has stored thereon instructions that when executed by one or more processors result in the following operations comprising: the method according to any one of examples 36 through 46.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A four stable state neuron comprising:
a plurality of input elements and a plurality of coupling channels, each input element coupled to a respective coupling channel and each input element to scale a respective two-dimensional input signal by a weight; and
a first output element coupled to the plurality of coupling channels, the first output element to receive the plurality of weighted two-dimensional input signals and to generate a two-dimensional output signal based, at least in part, on a threshold value.

2. The four stable state neuron of claim 1, wherein a first dimension of each two-dimensional input signal corresponds to a first spin current having a first orientation and a second dimension of each two-dimensional input signal corresponds to a second spin current having a second orientation and the first output element is to sum the plurality of weighted first spin currents and a first threshold value and to sum the plurality of weighted second spin currents and a second threshold value to generate the two-dimensional output signal.

3. The four stable state neuron of claim 1, wherein each input element is an input four stable state magnet and the output element is an output four stable state magnet, each state corresponding to an easy axis of the respective magnet.

4. The four stable state neuron of claim 1, further comprising an inverting output element coupled to the first output element, the inverting output element to invert the two-dimensional output signal.

5. The four stable state neuron of claim 1, further comprising a thresholding stage to implement an activation function.

6. The four stable state neuron of claim 5, wherein the activation function is sigmoidal.

7. The four stable state neuron of claim 4, wherein the inverting output element is a four stable state magnet, each state corresponding to an easy axis of the magnet.

8. An artificial neural network comprising:
a plurality of four stable state neurons, each four stable state neuron comprising:
a plurality of input elements and a plurality of coupling channels, each input element coupled to a respective coupling channel and each input element to scale a respective two-dimensional input signal by a weight; and
a first output element coupled to the plurality of coupling channels, the first output element to receive the plurality of weighted two-dimensional input signals and to generate a two-dimensional output signal based, at least in part, on a threshold value.

9. The artificial neural network of claim 8, wherein a first dimension of each two-dimensional input signal corresponds to a first spin current having a first orientation and a second dimension of each two-dimensional input signal corresponds to a second spin current having a second orientation and the first output element is to sum the plurality of weighted first spin currents and a first threshold value and to sum the plurality of weighted second spin currents and a second threshold value to generate the two-dimensional output signal.

10. The artificial neural network of claim 8, wherein each input element is an input four stable state magnet and the output element is an output four stable state magnet, each state corresponding to an easy axis of the respective magnet.

11. The artificial neural network of claim 8, wherein at least one neuron further comprises an inverting output element coupled to the first output element, the inverting output element to invert the two-dimensional output signal.

12. The artificial neural network of claim 8, wherein at least one neuron further comprises a thresholding stage to implement an activation function.

13. The artificial neural network of claim 12, wherein the activation function is sigmoidal.

14. The artificial neural network of claim 11, wherein the inverting output element is a four stable state magnet, each state corresponding to an easy axis of the magnet.

15. A system comprising:
a computing device comprising a processor and a memory; and
an artificial neural network coupled to the computing device, the artificial neural network comprising a plurality of neurons, each neuron comprising:
a plurality of input elements and a plurality of coupling channels, each input element coupled to a respective coupling channel and each input element to scale a respective two-dimensional input signal by a weight; and
a first output element coupled to the plurality of coupling channels, the first output element to receive the plurality of weighted two-dimensional input signals and to generate a two-dimensional output signal based, at least in part, on a threshold value.

16. The system of claim 15, wherein a first dimension of each two-dimensional input signal corresponds to a first spin current having a first orientation and a second dimension of each two-dimensional input signal corresponds to a second spin current having a second orientation and the first output element is to sum the plurality of weighted first spin currents and a first threshold value and to sum the plurality of weighted second spin currents and a second threshold value to generate the two-dimensional output signal.

17. The system of claim 15, wherein each input element is an input four stable state magnet and the output element is an output four stable state magnet, each state corresponding to an easy axis of the respective magnet.

18. The system of claim 15, wherein at least one neuron further comprises an inverting output element coupled to the first output element, the inverting output element to invert the two-dimensional output signal.

19. The system of claim 15, wherein at least one neuron further comprises a thresholding stage to implement an activation function.

20. The system of claim 15, wherein the weights are determined using a gradient descent technique.

21. The system of claim 15, wherein the weights are determined using a back propagation technique.

22. The system of claim 15, wherein the artificial neural network comprises a plurality of layers, each layer comprising at least one of the plurality of neurons.

23. The system of claim 15, wherein the computing device further comprises weight determination logic to determine the weights.

24. The system of claim 15, wherein the computing device further comprises a neural network interface to convert the spin currents to corresponding digital representations.

25. The system of claim 15, further comprising a voltage supply to provide a plurality supply voltages to the artificial neural network, each supply voltage related to a respective weight.
